(19) United States
(12) Patent Application Publication
(10) Pub. No.: US 2019/0322429 A1
(43) Pub. Date: Oct. 24, 2019

(54) FOOD-PACKAGING FILM WITH BARRIER PROPERTIES AGAINST MINERAL OIL

(71) Applicant: Treofan Germany GmbH & Co. KG, Neunkirchen (DE)

(72) Inventors: Thomas Gottfreund, Schiffweiler (DE); Detle Hütt, Heusweiler (DE)

(73) Assignee: Treofan Germany GmbH & Co. KG, Neunkirchen (DE)

(21) Appl. No.: 16/441,044

(22) Filed: Jun. 14, 2019

Related U.S. Application Data
(63) Continuation of application No. PCT/EP2017/000142, filed on Dec. 13, 2017.

(51) Int. Cl. B65D 65/42; B32B 27/10

(52) U.S. Cl. CPC B65D 65/42; B32B 27/18; B32B 2439/70; B32B 27/10

(57) ABSTRACT

The invention relates to a food packaging which comprises a coated biaxially oriented polypropylene film which acts as a barrier against mineral oils. The film comprises a multi-layered coating on at least one side.

### REFERENCE TO RELATED APPLICATIONS

This is a continuation application, which claims priority to PCT application PCT/EP2017/00142 filed on Dec. 13, 2017, which claims priority to German provisional application number 102016014893.4 filed on Dec. 15, 2016 that are incorporated by this reference in their entireties.

### FIELD

The present invention relates to a coated film which has barrier properties against mineral oils and food packaging produced therefrom.

### BACKGROUND

Polyolefin-based films, in particular biaxially oriented propylene (boPP) films, are nowadays used as packaging films in a wide range of applications. Polypropylene films are characterized by many advantageous use properties, such as high transparency, gloss, barrier to water vapor, good printability, rigidity, penetration strength, etc. The polypropylene films can be used both as transparent films and as opaque films.

For food packaging, cardboard packaging is also used that, due to its availability, is often present in the form of recycled cardboard. This results in problems, since recycled cardboards typically contain 300-1000 mg/kg mineral oil with a relatively low molar mass (primarily n-C18 to n-C22) and a content of aromatic components between 15-20% (opinion no. 008/2010 of the Federal Institute for Risk Assessment “BfR” of Sep. 12, 2009).

The mineral oil mixtures detected in recycled cardboard are paraffin-like (open-chained, usually branched) and naphthene-like (cyclical) hydrocarbons that are referred to as “mineral oil saturated hydrocarbons” (MOSH), and also aromatic hydrocarbons, “mineral oil aromatic hydrocarbons” (MOAH), which consist primarily of highly alkylated systems (see Biedermann M, Fiselier K, Grob K, 2009, “Aromatic hydrocarbons of mineral oil origin in foods: Method for determining the total concentration and first results. Journal of Agricultural and Food Chemistry 57: 8711-8721.

Without appropriate measures, there is a risk that the above-mentioned mineral oil mixtures contaminate the packaged food.

Polyolefin films, in particular biaxially oriented polypropylene films (boPP), have no suitable barrier properties against these mineral oil mixtures and alone cannot effectively prevent the migration.

In WO14072066A1 a food packaging is described which comprises a biaxially oriented polypropylene film and a recycled cardboard. The biaxially oriented polypropylene film (boPP) has on at least one surface of the film a coating of (i) acrylate polymers, and/or (ii) halogen-containing vinyl and/or vinylidene polymers, and/or (iii) polymers based on vinyl alcohol (VOH). Although the coating fundamentally improves the mineral oil barrier, it is still in need of further improvement with regard to this barrier effect.

Furthermore, the known polyacrylate-coated films are poor in processing performance, i.e., the friction and the sliding properties must be improved. This applies in particular to embodiments of the food packaging in which filled bag or wrapping packages are packed in a further wrapping cardboard packaging. In these cases, the film must have a good running behavior on the printing presses and the packing machines. But also in the case of lamination of recycled cardboard with film this laminating film is wound up, unwound and must be easily processed in the actual lamination process.

### SUMMARY

The object of the present invention was therefore to provide a biaxially oriented polypropylene film for food packaging made of recycled cardboard, which has a further improved barrier against mineral oil mixtures, so that contamination of the packaged food by the mineral oil mixture present in the recycling cardboard is avoided. The film must simultaneously have good processing properties, i.e., in particular, it must be usable on printing machines, packaging machines or in lamination devices without causing any problems.

This object is achieved by a food packaging comprising:

A) a food,
B) a coated film which is in contact with the food,
C) a cardboard based on a recycled cardboard which is in contact with the coated, biaxially oriented polypropylene film,
characterized in that the coated film B)
comprises a biaxially oriented polypropylene film comprising on at least one surface at least a first primer layer which is in contact with a surface of the biaxially oriented polypropylene film, and
which comprises a first inner coating which is in contact with the first primer layer and which contains no particulate additives and which contains at least one polymer based on acrylate or halogen-containing vinyl and/or vinylidene polymers or
at least one polymer based on vinyl alcohol (VOH), and which comprises a first outer coating which is in contact with the first inner coating and which forms the outer surface of the coated film and contains the friction reducing additives and which contains at least one polymer based on acrylate or halogen-containing vinyl and/or vinylidene polymers or at least one polymer based on vinyl alcohol (VOH).

This object is further achieved by a coated film comprising a biaxially oriented polypropylene film, which comprises on at least one surface at least one first primer layer, which is in contact with a surface of the biaxially oriented polypropylene film, and comprises a first inner coating which is in contact with the first primer layer and which contains no particulate additives and which comprises at least one polymer based on acrylate or halogen-containing vinyl and/or vinylidene polymers or contains at least one polymer based on vinyl alcohol (VOH), and comprises a first outer coating which is in contact with the first inner coating and which forms the outer surface of the coated film and contains the friction reducing additives and the at least one polymer based on acrylate or halogen-containing vinyl and/or vinylidene polymers or at least one polymer based on vinyl alcohol (VOH).

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIGS. 1A-1C depict example embodiments of films in accordance with the disclosed methods, structures, and compositions.

FIG. 2 depicts components used for migration measurements of coated films, i.e., the barrier medium, in accordance with the disclosed methods, structures, and compositions.

### DETAILED DESCRIPTION

The food packaging according to the invention does not require metallization, i.e., neither metallization of the film nor metallization of the cardboard is necessary to minimize contamination of the food with mineral oil. The invention can be realized by differently configured food packaging. In one embodiment, pouches or wrap packages containing the food are made with the coated film using technologies, which are known per se. The filled bag or wrap packaging is then packaged in a further encasing cardboard packaging. The coating on the outer side of the bag or wrap packaging prevents the migration of the mineral oils from the cardboard into the food. In a further embodiment the cardboard can be laminated or lined with the coated film. A packaging that contains the food is then produced from the coated cardboard. This variant is advantageous for packaging in which the food would otherwise come into direct contact with the cardboard, such as in an advent calendar.

The package of the invention ensures that the coated film minimizes or prevents the migration of mineral oils derived from the recycled board into the food. Therefore, there should be no direct contact between the cardboard and the food when designing the packaging individually. The food should only be in contact with the coated film.

The terms “acrylate” or “acrylates” “base film”, “coated film”, “primer layer”, “coating”, “polyacrylate” or acrylate polymer and “VOH polymer” in the context of the present invention have the following meaning, respectively:

“Acrylate” or “acrylates” generally designate the salts, esters, amides, acid chlorides, acid anhydrides and/or conjugated bases of acrylic acid (IUPAC: Prop-2-enoic acid, formula: H₂C═CH—COOH) and their (chemical) derivatives.

The “base film” is a biaxially oriented polypropylene film which does not yet have a primer layer and no coating.

“Primer layer” is a layer that is applied to the outer surface(s) of the base film and improves the adhesion of the subsequent coating(s).

“Coating” is a layer or also refers to several layers which contain (i) at least one polymer based on acrylate or (ii) halogen-containing vinyl and/or vinylidene polymers or (iii) at least one polymer based on vinyl alcohol (VOH),

The “coated film” comprises at least the base film, the primer layer(s) and the coating(s).

“Polyacrylate” or “acrylate polymer” is a polymer based on acrylate units, such as, for example, ethyl acrylate, ethyl methacrylate, methyl methacrylates, methyl acrylates and/or polybutyl acrylate, which may optionally also be polymerized as copolymers with at least one further comonomer.

“VOH polymer” is a polymer based on vinyl alcohols, for example ethylene vinyl alcohol polymers (EVOH) and/or polyvinyl alcohol (PVOH).

### Base Film:

The base film of the food packaging according to the invention is a biaxially oriented polypropylene film, which is constructed in one or more layers. Multilayer embodiments of the base film comprise a base layer and at least one, preferably two, cover layer(s) on both sides, which form the outer layer(s) of the base film. Optionally, the base film is constructed in four or five layers and additionally has on one or on both sides intermediate layer(s), which is/are attached between the base layer and the one or the cover layer(s). The base layer generally forms the central layer of the base film and has the largest thickness.

The thickness of the base film is generally in a range of 15 to 100 μm, preferably 20 to 80 1 μm, preferably 30 to 60 μm, in particular 25 to 50 μm. For multilayer embodiments of the base film, the thickness of the base layer is between 10 and 60 μm, preferably between 10 and 40 μm. The thickness of the cover layer(s) is generally 0.5 to 3 μm in each case. The intermediate layer(s) has/have a thickness in the range of 1 to 8 μm. In the case of a combination of intermediate layer and covering layer, these together preferably have a total thickness of 2 to 8 μm.

The single-layered base film or base layer of the multi-layered base film generally contains at least 50% by weight of propylene polymer, based on the total weight of the base film, and optionally further conventional additives in respective effective amounts. In general, the base layer or the base film contains at least 70 to <100% by weight, preferably 75 to 98% by weight, in particular 85 to 95% by weight, of the propylene polymer, each based on the weight of the base layer or on the weight of the base film.

Suitable propylene polymers contain 90 to 100% by weight, preferably 95 to 100% by weight, in particular 98 to 100% by weight, of propylene units and have a melting point of 120° C. or higher, preferably 150 to 170° C., and in general a melt flow index of 1 to 10 g/10 min, preferably 2 to 8 g/10 min, at 230° C. and a coating weight of 2.16 kg (DIN EN ISO 1133). Isotactic propylene homopolymer having an atactic content of 15% by weight and less, copolymers of ethylene and propylene having an ethylene content of 5% by weight or less, copolymers of propylene with C4-C8 olefins having an olefin content of 5% by weight or less, terpolymers of propylene, ethylene and butylene having an ethylene content of 10% by weight or less and having a butylene content of 15% by weight or less are preferred propylene polymers for the base layer, wherein isotactic propylene homopolymer having a melting point of 150 to 170° C. is particularly preferred. The stated percentages by weight relate to the respective polymer.

Furthermore, a mixture of said propylene homo and/or copolymers and/or terpolymers and other polyolefins, in particular from monomers having 2 to 6 carbon atoms, is suitable, wherein the mixture generally contains at least 50% by weight, in particular at least 70% by weight of propylene polymers. Suitable other polyolefins in the polymer mixture are polyethylenes, in particular HDPE, MDPE, LDPE, VLDPE and LLDPE, the proportion of these polyolefins in each case not exceeding 15% by weight, based on the polymer mixture.

In a multi-layered, opaque embodiment, the base layer of the base film contains vacuole-initiating fillers in an amount of at most 30% by weight, preferably 5 to 25% by weight, based on the weight of the opaque base layer, the proportion of propylene polymers being correspondingly reduced.

Vacuole initiating fillers are solid particles that are incompatible with the polymer matrix and result in the formation of vacuole-like voids upon stretching of the films. Usually, the vacuole-initiating fillers have a minimum size of 1 μm in order to produce an effective, i.e., opacifying number of vacuoles. In general, the average particle diameter of the particles is 1 to 6 μm, preferably 1.5 to 5 μm. The chemical character of the particles plays a minor role.

Typical vacuole-initiating fillers are inorganic and/or organic, polypropylene incompatible materials such as alumina, aluminum sulfate, barium sulfate, calcium carbonate, magnesium carbonate, silicates such as aluminum silicate (kaolin clay) and magnesium silicate (talc) and silica, among which calcium carbonate and silica are preferably used. Suitable organic fillers are commonly used polymers which are incompatible with the polymer of the base layer, in particular copolymers of cyclic olefins (COC) as described in EP-A-0 623 463, polyesters, polystyrenes, polyamides, halogen-containing organic polymers, where polyesters such as, for example, polybutylene terephthalates and cycloolefin copolymers are preferred. Incompatible materials or incompatible polymers in the sense of the present invention are materials or polymers present in the film as a separate particle or as a separate phase.

In a further opaque embodiment, the base layer or the single-layered base film can contain, additionally or alternatively to the vacuole-initiating fillers, pigments, for example in an amount of 0.5 to 10% by weight, preferably 1 to 8% by weight, in particular 1 to 5% by weight. The data relate to the weight of the base layer or to the weight of the base film. Again, the proportion of propylene polymers is reduced accordingly.

For the purposes of the present invention, pigments are incompatible particles which essentially do not lead to the formation of vacuoles during stretching of the film. The coloring effect of the pigments, for example, is caused by the particles themselves. The term “pigments” is generally connected to an average particle diameter in the range from 0.01 to a maximum of 1 μm and comprises both so-called “white pigments” which color the films white, and “colored pigments” which provide a colored or black film. In general, the mean particle diameter of the pigments is in the range of 0.01 to 1 μm, preferably 0.01 to 0.7 μm, in particular 0.01 to 0.4 μm.

Common pigments are materials such as alumina, aluminum sulfate, barium sulfate, calcium carbonate, magnesium carbonate, silicates such as aluminum silicate (kaolin clay) and magnesium silicate (talc), silica and titanium dioxide, among which white pigments such as calcium carbonate, silica, titanium dioxide and barium sulfate are preferably used. Titanium dioxide is particularly preferred. Various modifications and coatings of TiO₂ are known per se in the art.

The density of the multilayer base film is substantially determined by the density of the base layer. In general, the density of the base layer or the density of the base film is in a range of 0.45-0.95 g/cm³. The vacuoles reduce the density, pigments increase the density of the base layer or the base film compared to the density of polypropylene.

The cover layer(s) of the multilayer base film can be configured as a sealable layer(s), which is understood to mean both heat-sealable and also cold-sealable layers. Cold sealable coatings can be applied directly to the surface of a single layer base film. Generally, however, it is preferred to apply the cold sealable coating to the cover layer of the multilayer base film. Suitable materials for heat-sealable cover layer(s) are the copolymers and terpolymers mentioned below. Non-sealable embodiments of the multilayer base film are formed by the propylene homopolymers described for the base layer.

The heat-sealable topcoat(s) of the multilayer base film generally contain at least 80% by weight, preferably 90 to <100% by weight, of olefinic polymers or blends thereof. Suitable polyolefins are, for example, polyethylenes, propylene copolymers and/or propylene terpolymers.

Suitable propylene copolymers or terpolymers are generally composed of at least 50% by weight of propylene units and of ethylene and/or butylene units as comonomer. Preferred copolymers are random ethylene-propylene copolymers having an ethylene content of from 2 to 10% by weight, preferably from 5 to 8% by weight, or random propylene-butylene-1 copolymers having a butylene content of from 4 to 25% by weight, preferably 10 to 20% by weight, each based on the total weight of the copolymer or random ethylene-propylene-butylene-1 terpolymers having an ethylene content of 1 to 10% by weight, preferably 2 to 6% by weight, and a butylene-1 content of 3 to 20% by weight, preferably 8 to 10% by weight, each based on the total weight of the terpolymer. These copolymers and terpolymers generally have a melt flow index of 3 to 15 g/10 min, preferably 3 to 9 g/10 min (230° C., 2.16 kg DIN EN ISO 1133) and a melting point of 70 to 145° C., preferably 90 to 140° C. (DSC).

Suitable polyethylenes are, for example, HDPE, MDPE, LDPE, LLDPE, VLDPE, of which HDPE and MDPE types are particularly preferred. The HDPE generally has an MFI (50 N/190° C.) of greater than 0.1 to 50 g/10 min, preferably 0.6 to 20 g/10 min, measured according to DIN EN ISO 1133 and a viscosity number, measured according to DIN 53 728, Part 4 or ISO 1191, in the range of 100 to 450 cm³/g, preferably 120 to 280 cm³/g. The crystallinity is 35 to 80%, preferably 50 to 80%. The density, measured at 23° C. according to DIN EN ISO 1183-1, is in the range of >0.94 to 0.96 g/cm³. The melting point, measured with DSC (maximum of the melting curve, heating rate 20° C./min), is between 120 and 140° C. Suitable MDPE generally has an MFI (50 N/190° C.) of greater than 0.1 to 50 g/10 min, preferably 0.6 to 20 g/10 min, measured according to DIN EN ISO 1133. The density, measured at 23° C. according to DIN EN ISO 1183-1, is in the range of >0.925 to 0.94 g/cm³. The melting point, measured by DSC (maximum of the melting curve, heating rate 20° C./min), is between 115 and 130° C.

The interlayer(s) of the four- and five-layer embodiments of the multilayer base film are generally composed of the propylene homopolymers described for the base layer. Opaque embodiments of the base film may contain in the intermediate layers the pigments described above for the base layer, generally in an amount of from 2 to 10% by weight, preferably in an amount of from 3 to 7% by weight.

To improve the adhesion and the printability, the surface of the base film can be subjected to a method for increasing the surface tension in a conventional manner by means of corona, flame or plasma. Typically, the surface tension of the base film thus treated is then in a range of 35 to 45 mN/m. This surface treatment can be done on one or both surfaces of the base film.

The base film generally contains in the respective layers customary stabilizers and neutralizing agents in customary amounts, as well as, if appropriate, antiblocking agents in the cover layer(s). As lubricants and antistatic agents, only those additives are added to the layers which do not impair the adhesion of the subsequently applied primer layer and coatings or the amount of such additives is correspondingly reduced.

As stabilizers, the usual stabilizing compounds for ethylene, propylene and other olefin polymers can be used. Their additional amount is between 0.05 and 2% by weight. Particularly suitable are phenolic stabilizers, alkali/alkaline earth stearates and/or alkali/alkaline earth carbonates. Phenolic stabilizers are preferred in an amount of from 0.1 to 0.6% by weight, in particular from 0.15 to 0.3% by weight, and with a molecular weight of more than 500 g/mol. Pentaerythrityl tetrakis-3-(3,5-di-tert-butyl-4-hydroxyphenyl) propionate or 1,3,5-trimethyl-2,4,6-tris(3,5-di-tert-butyl-4-hydroxybenzyl)benzene are particularly advantageous.

Neutralizing agents are preferably calcium carbonate and/or dihydrotalcite (DHT) having an average particle size of at most 0.7 μm, an absolute particle size of less than 10 μm and a specific surface area of at least 40 m²/g. In general, neutralizing agents are used in an amount of 50 to 1000 ppm based on the layer.

Suitable antiblocking agents are inorganic additives such as silica, calcium carbonate, magnesium silicate, aluminum silicate, calcium phosphate and the like and/or incompatible polymers such as polymethyl methacrylate (PMMA) polyamides, polyesters, polycarbonates and the like, preferably polymethylmethacrylate (PMMA), silica and calcium carbonate. The effective amount of antiblocking agent is in the range of 0.1 to 2% by weight, preferably 0.1 to 0.5% by weight, based on the respective cover layer. The average particle size is between 1 and 6 m, in particular 2 and 5 μm, particles having a spherical shape, as described in EP-A-0 236 945 and DE-A-38 01 535, being particularly suitable.

### Production Process Base Film:

The preparation of the base film is carried out by means of per se known extrusion or coextrusion method, wherein in particular the stenter-method is preferred.

For this purpose, corresponding to the individual layers of the film, melts are coextruded through a flat die, the resulting film withdrawn for solidification on one or more roller(s), then stretched (oriented), the stretched film is then heat-set and optionally subject at the surface layer intended for treatment to a plasma corona or flame treatment.

In detail, in this case, as in the extrusion process, the polymer or the polymer mixture of the individual layers is compressed and liquefied in an extruder, wherein optionally added additives may already be present in the polymer or in the polymer mixture. Alternatively, these additives can also be incorporated via a masterbatch.

The melts are then pressed together and simultaneously through a flat die (wide slit nozzle), and the extruded multilayer film is drawn off on one or more draw-off rolls at a temperature of from 5 to 100° C., preferably from 10 to 50° C., whereby they are cooled and solidified.

The resulting film is then stretched longitudinally and transversely to the extrusion direction, resulting in orientation of the molecular chains. The longitudinal stretching is preferably carried out at a temperature of 80 to 150° C. advantageously with the help of two rolls rotating at different speeds corresponding to the desired stretch ratio and the transverse stretching is preferably carried out at a temperature of 120 to 170° C. by means of a corresponding clip frame. The longitudinal stretching ratios are in the range of 4 to 8, preferably 4.5 to 6. The transverse stretching ratios are in the range of 5 to 10, preferably 7 to 9.

The stretching of the film is followed by its heat-setting (heat treatment), the film being kept at a temperature of 100 to 160° C. for about 0.1 to 10 seconds. Subsequently, the film is wound up in the usual manner with a winding device.

Preferably, after biaxial stretching, one or both surfaces of the film are plasma-treated, corona-treated or flame-treated according to one of the known methods. The treatment intensity is generally in the range of 35 to 45 mN/m, preferably 37 to 45 mN/m, in particular 38 to 41 mN/m.

For the alternative corona treatment, the film is passed between two conductor elements serving as electrodes, whereby a high voltage, usually alternating voltage (about 10,000 V and 10,000 Hz), is applied between the electrodes so that spraying or corona discharges can take place. The spray or corona discharge ionizes the air above the film surface and reacts with the molecules of the film surface to form polar inclusions in the substantially non-polar polymer matrix. The treatment intensities are within the usual range, wherein 37 to 45 mN/m being preferred.

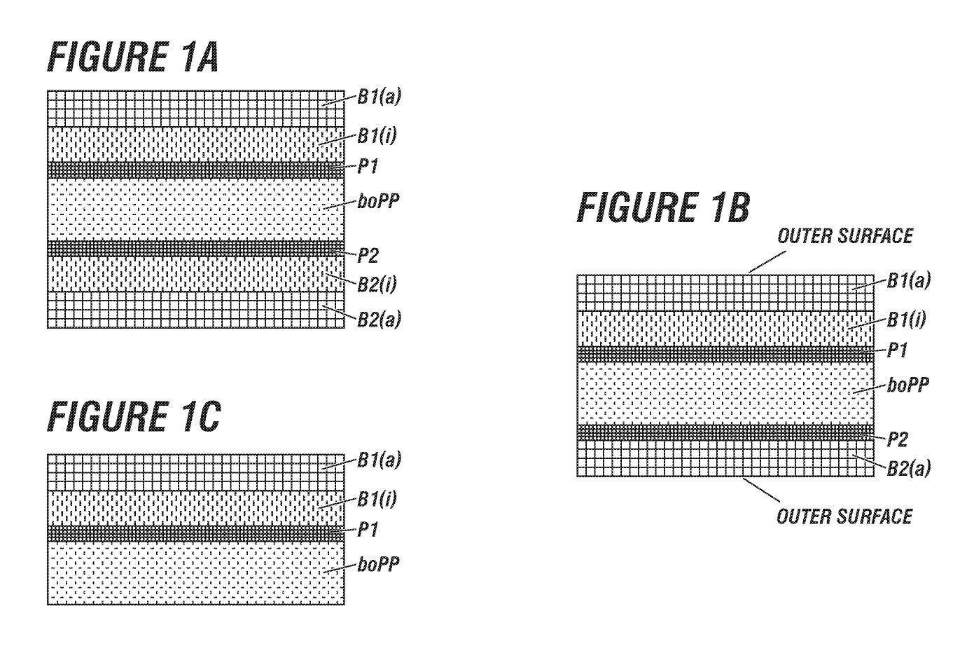

FIGS. 1a to 1c show various possible embodiments of the film according to the invention. FIG. 1a shows a film which has on the first side of the base film (boPP) a primer layer P1 and an inner coating B1(i) and an outer coating B1(a) and on the second side of the base film (boPP) a primer layer P2 and an inner coating B2(i) and an outer coating B2(a). FIG. 1b shows a film which has on the first side of the base film (boPP) a primer layer P1 and an inner coating B1(i) and an outer coating B1(a) and on the second side of the base film (boPP) a primer layer P2 and an outer coating B2(a). FIG. 1 c shows a film which has a primer layer P1 and an inner coating B1(i) and an outer coating B1(a) on the first side of the base film (boPP) and no further layers on the second side of the base film (boPP).

### Primer Layer(s)

The base film is provided on at least one surface with a primer layer according to the methods known per se in order to improve the adhesion of the subsequently applied coating.

In general, the base film is first surface-treated on the side to be coated by means of flame, plasma or corona to increase the surface tension and to improve the adhesion of the primer to the base film. After the surface treatment, a primer layer is applied to this treated surface, generally an aqueous polyethyleneimine solution (e.g., 0.5 to 5% by weight, preferably 0.5 to 3% by weight) and dried. The aqueous polyethyleneimine solution favors the subsequent coating, as described, for example, in EP-A-0255870 and is used as a solution with preferably 1% by weight of polyethyleneimine. Polyethyleneimine primer layers improve adhesion to subsequently applied coatings and are well known in the art and are applied according to these known teachings. In principle, it is also possible to apply other known primer layers which improve the adhesion of the subsequent coating.

For example, it is advantageous for a subsequent coating of halogen-containing vinyl and/or vinylidene polymers, in particular for coatings with polyvinylidene dichloride (PVDC), to additionally apply a secondary primer layer based on acrylate/vinyl acetate copolymer. The layer thickness of the secondary primer layer is usually 25 to 100% of the layer thickness of the later coating of the halogen-containing vinyl and/or vinylidene polymers, in particular polyvinylidene dichloride (PVDC).

For embodiments of the coated film coated on both sides, the opposite surface of the base film is treated in the same manner and also provided with a primer layer, in which case the above description of the primer layer applies in an analogous manner for this second primer layer.

The coating weight of the respective primer layer is generally 0.02 to 1.0 g/m², preferably 0.5 to 0.5 g/m². The primer layer(s) are generally substantially free of anti-blocking agents, lubricants, or other additives that affect adhesion to the film or adhesion to the subsequent coating or other film properties.

### Coating(s)

The coated film according to the invention comprises at least one multilayer coating which contains (i) acrylate polymers or (ii) halogen-containing vinyl and/or vinylidene polymers or (iii) vinyl alcohol (VOH) based polymers. The multilayer coating may be on one or both sides of the base film with primer layer(s). In this case, all layers of the coating may contain the same polymers or various polymers are used for the coatings, such as acrylate polymers and polyvinylidene dichloride (PVDC). The multilayer coating comprises an inner coating B(i) in contact with the primer layer and an outer coating B(a) in contact with the inner coating B(i). It is essential to the invention that the inner coating B(i) contains no particulate additives, or the amount thereof is so low that the barrier properties of the film are not impaired. Furthermore, it is essential to the invention that the outer coating B(a) contains at least one friction reducing additive. For the inner and the outer coating, in principle, the same polymers or different polymers can be used. The coating is referred to as multi-layered, since the two layers differ at least with regard to their additives. In general, said polymers (i), (ii) and (iii) are not mixed together in one layer, i.e., these are each arranged as a concrete layer of the polymers (i), (ii) or (iii). This naturally does not exclude the use of mixed polymers, such as a coating with copolymers.

In general, the respective layers B(i) and B(a) contain at least 80 to approx. 100% by weight of the polymers (i), (ii) or (iii), preferably 95 to <100% by weight, i.e., the respective layers are generally composed only of the stated polymers (i), (ii) or (iii) and contain the additives described in the outer coating B(a) and optionally conventional additives in small amounts of <5% by weight, so that the essential film properties are not adversely affected by these conventional additives.

As acrylate polymers (i), acrylate homopolymers and/or acrylate copolymers are used. Acrylate homopolymers are, for example, polyalkyl acrylates, preferably polymethyl methacrylate, polyethyl acrylate, polyethyl methacrylate, polymethyl acrylates and/or polybutyl acrylate. Acrylate copolymers are also preferably based on alkyl acrylates, preferably methyl methacrylate, ethyl acrylate, ethyl methacrylate and/or methyl acrylate and additionally contain comonomers such as, for example, acrylic acid units or styrene units. Such materials are available, for example, under the trademark NeoCryl BT-36 and NeoCryl FL-715 from DSM Coating Resins (Netherlands).

The halogen-containing vinyl and/or vinylidene polymers (ii) used according to the invention are preferably polymers based on vinyl chloride and/or vinylidene chloride, which, as copolymers, may also contain other monomers, in particular based on vinyl acetate or acrylate. Such polymers are available on the market, for example, under the trademark Diofan® A 297, Diofan® A 114 or Diofan® B 200 from SolVin. S.A. (Belgium).

Preferred coatings based on vinyl alcohol-based polymers (iii) are composed of ethylene-vinyl alcohol polymers (EVOH) and/or polyvinyl alcohols (PVOH) and preferably comprise a mixture of ethylene vinyl alcohol and polyvinyl alcohol, preferably in the ratio 0.8-1.2 to 1.2-0.8, in particular 1:1 (weight ratios).

The respective polymers for the coating are applied as dispersion, in particular aqueous dispersion, whose solids content is generally 20-50% by weight. Aqueous dispersions of the polymers based on vinyl alcohols contain from 5 to 15% by weight of polymers.

Inner Coating B(i) without Additives

According to the invention, at least one side of the base film with primer layer is coated twice with one of the abovementioned polymers (i), (ii) or (iii). Thus, the film coated according to the invention comprises the described base film, at least one first primer layer P1, a first inner coating B1(i) in contact with the previously applied primer layer P1, and another outer coating B1(a) in contact with the inner coating B1(i) and which forms the outer layer of the coated film. The order of the layers in the film thus corresponds to base film/primer layer P1/first inner coating B1(i)/first outer coating B1(a). According to the invention, the inner coating B1(i) contains no particulate additives.

In a preferred embodiment, the multilayer coating described above is applied on both surfaces of the base film with double-sided primer layers. This film then comprises on the second side of the base film a second primer layer P2, a second inner coating B2(i) in contact with the previously applied primer layer P2 and a second outer coating B2(a) in contact with the second inner coating B2(i) and forms the opposite cover layer of the coated film. According to the invention, the inner coating B2(i) also contains no particulate additives. These embodiments thus have the following structure B2(a)/B2(i)/P2/bopp/P1/B1(i)/B1(a).

In a further embodiment, a second primer layer P2 and a single-layer second coating B2(a), which is in direct contact with the primer layer P2, are applied on the second surface of the base film. The composition of this single-layer coating then corresponds in terms of composition and coating weight to the outer coating described above B2(a) or B1(a). These embodiments thus have the following structure B2(a)/P2/bopp/P1/B1(i)/B1(a).

Preferably, the inner coating(s) B1(i) and B2(i) together hereinafter called B(i) are composed of polyacrylates (i), preferably polymethylmethacrylate, polyethylacrylate, polyethylmethylacrylate, polymethylacrylate and/or polybutylacrylate, wherein these acrylate polymers may also be polymerized as copolymers with at least one further co-monomer. In accordance with the invention, the inner coating(s) do(es) not contain any particulate additives, such as anti-blocking agents. Most preferably, the inner coating(s) also contains no waxes.

The inner coating(s) B(i), preferably the polyacrylate layer, is/are applied after application and drying of the primer layer or primer layers directly onto the surface of the primer layer(s) and also dried. The coating weight of the inner coating(s) B(i), preferably the polyacrylate layer, after drying, is in each case from 0.5 to 1.5 g/m².

In a further embodiment, for the inner coating(s) B(i), the (ii) halogen-containing vinyl and/or vinylidene polymers (ii) can be used. The suitable aqueous coating solutions based on halogen-containing vinyl and/or vinylidene polymers, in particular polyvinylidene dichloride (PVDC), contain 85-95% by weight of PVDC acrylate copolymer, which, as already mentioned, are preferably applied to a secondary primer layer P1′ based on acrylate/vinyl acetate copolymer. The coating weight of the inner coating(s) of the halogen-containing vinyl and/or vinylidene polymers is also 0.5 to 1.5 g/m² after drying.

Outer Coating B(a) with Additives

After application of the inner coating B(i), the application of the outer coating B1(a) and optionally B2(a), hereinafter together referred to as B(a), on the surface of the inner coating(s) B(i) with the above polymers (i), (ii) or (iii) takes place. According to the invention, the outer coating(s) B(a) contains friction reducing additives, preferably particulate additives and/or waxes.

The outer coating(s) B(a) is/are preferably composed of the polyacrylates (i), in particular of polymethyl methacrylate, polyethyl acrylate, polyethylmethyl acrylate, polybutyl acrylate and/or polymethyl acrylates, and preferably contain 0.01 to 15% by weight of friction reducing additives, preferably particulate additives, in particular antiblocking agents and/or 1 to 15% by weight waxes. Preferred particulate additives are, for example, silicates, SiO2, polymethyl methacrylate particles, crosslinked siloxanes (e.g., Tospearl®) or talc, of which SiO2 and/or silicates are preferred. The stated percentages by weight are in each case based on the weight of the dried coating(s) B(a). The coating weight of the outer coating(s) B(a), preferably the polyacrylate layer, after drying, is 0.5 to 1.5 g/m² in each case. The coating weight of the primer layer and the inner coating and the outer coating on one side of the film is preferably 1.5 to 4 g/m² in total.

Preferred waxes are, for example, natural waxes, paraffin waxes, microcrystalline waxes, carnauba wax, Japan wax, montan wax, etc., or synthetic waxes, e.g., polyethylene waxes. These waxes are mixed as dispersions with the coating solutions of the polymers (i), (ii) or (iii) and the wax-containing mixtures are used for coating.

Preferred aqueous coating solutions for the outer coating(s) B(a) based on the acrylate polymers include 70-80% by weight polyacrylate dispersion, 2-10% by weight wax dispersion, 2-10% by weight amorphous silica and 0.01-5% by weight of SiO2 as antiblocking agent. The SiO2 generally has an average particle size of 1 to 5 μm, preferably 3 to 4 μm.

In another embodiment, for the outer coating(s) B(a), the (ii) halogen-containing vinyl and/or vinylidene polymers (ii) can be used. The suitable aqueous coating solutions based on halogen-containing vinyl and/or vinylidene polymers, in particular polyvinylidene dichloride (PVDC), contain 80 to 95% by weight PVDC acrylate copolymer, 2 to 10% by weight wax dispersion, 0.01-5% by weight of an antiblocking agent, which, as already mentioned, are preferably applied to a secondary primer layer based on vinyl acetate/acrylate. Here, the same lubricants and particle additives as used for the layer of acrylate polymer, are used or preferred.

In the context of the present invention, it has been found that the barrier effect of the coating on mineral oils, in particular the coatings of acrylate polymers, is impaired by additives such as antiblocking agents and/or waxes for improving friction and sliding behavior. Various additives were used in a monolayer polyacrylate coating, their amounts were varied and thicker polyacrylate coatings were tested, but no film could thus be produced, which had a sufficiently good property profile in terms of barrier effect and processing properties, in particular with regard to barrier effect and friction.

Surprisingly, a good friction and a good barrier effect can be realized simultaneously if an inner coating B(i), preferably a polyacrylate layer without particulate additives, is combined with an outer coating B(a), preferably of polyacrylate, which contains particles. Surprisingly, the particles develop a friction reducing effect in the manner known per se and desired, but at the same time the barrier effect of the coating, preferably the polyacrylate coating, is not impaired, but instead surprisingly improved.

Although the improved friction due to the addition of the particles to the outer coating, preferably the polyacrylate layer, was to be expected in principle, it was surprising that two layers with moderate or poor barrier effect, when combined, showed a very good barrier effect. Thus, the present invention is based on a synergistic effect that was unpredictable in such a way.

The inner coating with a coating weight of 0.5 to 1.5 g/m² alone has only a moderate barrier effect on mineral oils. In addition, such a film cannot be processed because of poor friction. The outer coating with antiblocking agents alone does not in fact prevent the migration of the mineral oils. It is therefore extremely surprising that the combination of the cover layer without significant barrier effect with the thin inner layer with moderate barrier effect shows a much better overall effect than the theoretical sum of the two layers. Surprisingly, the cover layer, which alone has little or no effect, significantly improves the barrier effect overall.

According to the invention a film can thus be provided which offers a good barrier effect against mineral oils and at the same time has an excellent low friction coefficient and thus meets all requirements in terms of processability.

The coated film of the invention has a coefficient of friction in the range of 0.1 to 0.5, preferably 0.2 to 0.45. The coated film may be printed and/or laminated on the outer surface(s) in a conventional manner.

From the coated film of the invention food packagings are produced in a conventional manner. For this purpose, the coated film can be printed in the usual way on the one or more outer surfaces. In one embodiment, pouches or wrap packages containing the food are made from the coated film using technologies which are known per se. The filled bag or wrap packaging is then packaged in another wrapping cardboard package. The multilayer coating according to the invention of the bag or wrap packaging prevents migration of the mineral oils from the cardboard into the food. In another embodiment, the cardboard may be laminated or coupled with the coated film. A package containing the food is then made with the coated cardboard. This variant is advantageous for packagings, in which the food would otherwise be in direct contact with the cardboard.

### Definition of Recycling Carton:

The carton based on recycled cardboard used in the present invention is cardboard containing significant quantities of mineral oils and is therefore classified in accordance with Commission Regulation (EC) No 1935/2004 of 27 Oct. 2004.

Such recycled cardboard based cartons typically contain from 300 to 1000 mg/kg of mineral oil. These mineral oils are referred to as “mineral oil saturated hydrocarbons” (MOSH) or “mineral oil aromatic hydrocarbons” (MOAH). The MOSH and MOAH mineral oils are often still specified in terms of their carbon chains, e.g., as MOSH 14-24, MOSH 24-35, MOAH 14-24, and MOAH 24-35, the numerical values indicating the number of carbon atoms. The exact composition of the MOSH and MOAH mineral oils depends on the type of recycled board, i.e., the fractions of MOSH 14-24, MOSH 24-35, MOAH 14-24 and MOAH 24-35 are different. The packaging according to the invention is thus to be designed so that the cardboard and the food have no direct contact.

A determination of all substances used in printing inks (e.g., as a solvent) and which thus may occur as an impurity in recycled cardboard, is not possible with reasonable effort due to the large number of these substances. In addition, most substances have not yet been definitively clarified as to whether they have a toxicological effect. A functional barrier should therefore prevent as far as possible the transfer of all substances into the food or reduce it so far that a health risk can be excluded. This eliminates the need to examine and toxicologically assess a variety of substances. In collaboration with Koni Grob, a test method was developed in the Cantonal Laboratory Zurich that allows evaluation of barrier media with regard to their general effectiveness (SVI Guideline 2015.01_Innnenbeutel). This method is based on studies with n-heptadekane (C17), dipropyl phthalate (DPP) and 4-methylbenzophenone (MBP) as surrogate substances. It is believed that a medium which effectively prevents the passage of n-heptadekane (C17), dipropyl phthalate (DPP) and 4-methylbenzophenone (MBP) also represents a barrier to the mineral oil contaminants of the recycled board.

The film with the multilayer coating of the invention provides a particularly good barrier against the surrogates n-heptadekane (C17), dipropyl phthalate (DPP) and 4-methylbenzophenone (MBP) and thus also forms an effective barrier to the MOSH and MOAH contents of the mineral oils.

The film according to the invention can be used particularly advantageously for the production of food packaging comprising recycled cardboard, for example by coupling or laminating the film according to the invention with the cardboard. Symmetrical embodiments of the film with additional inner coatings B(i) on both sides may be joined to the cardboard by the first or second side. Coated films which have the multilayer coating only on one (first) side can in principle be connected to the cardboard with this first or with the opposite second side. Here, it is preferable to connect the opposite second side to the cardboard so that the food is in contact with the multi-layered coating. This embodiment is particularly advantageous and shows the least contamination of the food.

The following measuring methods were used to characterize the raw materials and the films:

### Melt Flow Index

The melt flow index was measured according to DIN EN ISO 1133 at 2.16 kg load and 230° C.

### Determination of the Ethylene Content

The ethylene content of the copolymers is determined by 3C-NMR spectroscopy. The measurements were carried out with a Bruker Avance 360 nuclear magnetic resonance spectrometer. The copolymer to be characterized is dissolved in tetrachloroethane, so that a 10% mixture is formed. As reference standard, octamethyl tetrasiloxane (OTMS) was added. The nuclear resonance spectrum was measured at 120° C. The evaluation of the spectra was carried out as described in J. C. Randall Polymer Sequence Distribution (Academic Press, New York, 1977).

### Melting Point and Enthalpy of Fusion

The melting point and the enthalpy of fusion are determined by means of DSC (differential scanning calorimetry) measurement (DIN 51 007 and DIN 53 765). Several milligrams (3 to 5 mg) of the raw material to be characterized are heated in one differential calorimeter at a heating rate of 20° C. per minute. The heat flow rate is plotted against the temperature and the melting point is determined as the maximum of the melting curve and the enthalpy of fusion as the area of the respective melt peak.

### Density

The density is determined according to DIN EN ISO 1183-1.

### Friction

The friction is determined according to DIN EN ISO 8295 or ISO 8295.

### Surface Tension

The surface tension was determined by an ink method according to ISO 8296.

### Migration Measurement

The migration measurements are based on the SVI guideline 2015.01_lnnenbeutel. For the examination of a barrier medium, it is initially assumed that a cardboard without recycled content is present, i.e., this cardboard was made only from unused cellulose fibers. The cardboard has a basis weight of about 300 g/m². For use as a donor, the board is treated with n-heptadekane (C17), dipropyl phthalate (DPP) and 4-methylbenzophenone (MBP), known as surrogates, wrapped in aluminum film and then conditioned at 40° C. for two weeks to allow an even distribution of the surrogates in the cardboard. The content of surrogates in the cardboard is checked after this storage and should then be about 40 mg/kg (=100%). This cardboard is then used as a donor in the subsequent measurement.

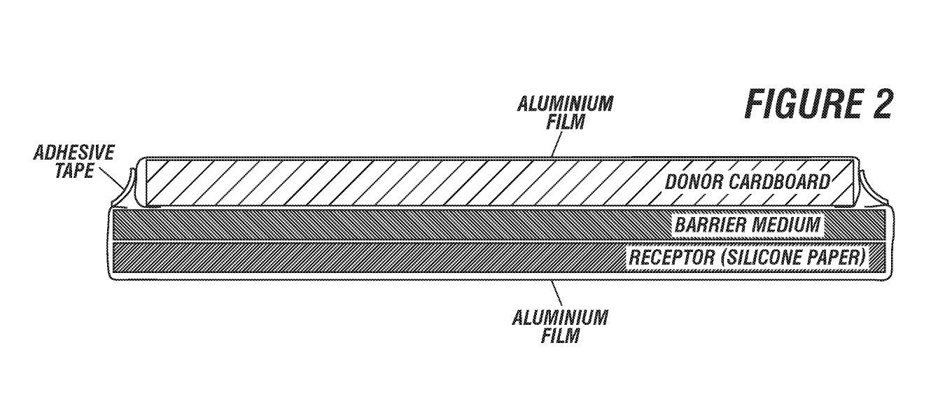

For this purpose and as shown in FIG. 2, the coated film to be tested (barrier medium) is applied flat to the donor. A silicone paper (115 g/m² photocopy paper soaked with 20% dimethylpolysiloxane), the so-called receptor, which can absorb the surrogates that pass through the barrier medium in the course of the test was placed on the barrier medium to be tested. The individual layers may be fixed with an adhesive tape. Donor, barrier medium and receptor are then wrapped together in aluminum film. This package is stored for 76 days in a warming cabinet at 40° C.

The receptor is removed from the package after 76 days and analyzed for surrogate content. This determination of the surrogate in the receptor is carried out by gas chromatography with a downstream FID unit. These measurement results are converted to 365 days at room temperature using the Arrhenius equation. In Table 3, these converted values are given as the result, i.e., how many % of the donor's surrogate substances enter the receptor after 365 days at room temperature. Ideally, no more than 1% of any surrogate should have entered the receptor after 365 days at room temperature.

The invention will now be illustrated by the following examples.

### Production of the Base Film:

### BOPP Base Film F1

By coextrusion and subsequent stepwise orientation in the longitudinal and transverse direction, a transparent three-layer film was produced with cover layers on both sides and with a total thickness of 20 μm. The cover layers each had a thickness of 0.9 μm.

### Base Layer:

Approximately 100% by weight of isotactic propylene homopolymer having a melting point of 166° C. and a melt flow index of 3.4 g/10 min.

### Outer Layers:

Approximately 100% by weight of ethylene-propylene-butylene random terpolymer with an ethylene content of 3% by weight and a butylene content of 7% by weight (remainder of propylene), with a melting point of 133° C. and a melt flow index of 5.5 g/10 min.

0.1% by weight of SiO2 as antiblocking agent with an average particle size of 4.5 pm The production conditions in the individual process steps were:

Extrusion: Temperature of base layer 260° C.
Cover layers: 240° C.
Temperature of take-off roll: 20° C.

Longitudinal stretching: Temperature: 110° C.
Longitudinal stretching ratio: 5.0

Transverse stretching: Temperature: 160° C.
Transverse stretch ratio: 9

Fixation: Temperature: 140° C.
Convergence: 20%

All layers of the film contained neutralizing agents and stabilizers in the usual amounts.

Both surfaces of the base film were pretreated by corona to increase the surface tension.

### Primer and Polyacrylate Coating:

On both sides of the above-described uncoated base film according to Example F1, a primer of a 1% by weight polyethyleneimine dispersion is first applied and dried. The coating weight of the primer layer after drying is in each case about 0.1 g/m². Subsequently, coatings of acrylate polymer were applied to both dried primer layers. Two different polyacrylate dispersions were used for this purpose:

A (i): acrylate without additives for the inner coating B(i)

76.8% by weight of DSM NeoCryl® FL-715

23.2% by weight water

The solids content of this dispersion was approx. 20-25% by weight. The coating dispersion A (i) contained no further additives and was thus free of anti-blocking agents and waxes.

A(a): acrylate with waxes and antiblocking agents for outer coating B(a)

76.8% by weight DSM NeoCryl® FL-715

5.2% by weight Michelman Michem® Lube 160PF

7.8% by weight Grace Davison Ludox® HS40

0.2% by weight of a 10% dispersion of Grace Davison Syloid® 244 in water

10.0% by weight of water

The solids content of this dispersion was approx. 20-25% by weight.

### Example B1

The first side or surface of the base film with dried primer layers P1 and P2 was coated by means of a gravure roller with the dispersion A(a) with additives on the primer layer P1 and dried. Subsequently, the opposite second side was coated—likewise by means of a gravure roller—with the dispersion A(i) (without additives). After drying of this inner polyacrylate coating the application of a further coating with the dispersion A (a) was carried out on the second side of the film. After drying, a film is obtained which has polyacrylate coatings on both sides and corresponds to a layer structure of B1(a)/P1/F1/P2/B2(i)/B2(a).

The coating weight of the monolayer polyacrylate coating B1(a) on side 1 of the film is about 0.9 g/m². The coating weight of the two-layered polyacrylate coating B2(i)/B2(a) on side 2 of the film was about 2.0 g/m², with each polyacrylate layer making up about 1 g/m².

In this way, a film was produced which had the following layer structure: outer polyacrylate layer with antiblocking agent and wax/primer/boPP/primer/inner polyacrylate layer/outer polyacrylate layer with antiblocking agent and wax.

### Example B2

A coated film was prepared as described in B1. In contrast to example B1, a second inner polyacrylate layer of dispersion A(i) was additionally applied to side 1. The coating weight of this second inner polyacrylate layer was about 1.0 g/m². In this way, a film was produced which had on both sides an inner polyacrylate layer without additives and an outer polyacrylate layer with antiblocking agent and waxes. The film thus had the following layer structure: outer polyacrylate layer with antiblocking and wax/inner polyacrylate layer/primer/boPP/primer/inner polyacrylate layer/outer polyacrylate layer with antiblocking and wax. The remaining coatings of the film were not changed compared to Example B1.

### Example B3

A coated film was produced as described in B2. In contrast to Example B2, the coating weight of the inner polyacrylate layer on the side 2 of the film was increased. The coating weight of the inner polyacrylate layer without antiblocking agent and without wax was now 1.3 g/m². Otherwise, the coatings of the film were not changed compared to Example B1.

### Example B4

A coated film was produced as described in B2. In contrast to Example B2, the coating weight of the two inner polyacrylate layers was increased. The coating weight of the inner polyacrylate layers without antiblocking agent and without wax was now 1.3 g/m² in each case. Otherwise, the coatings of the film were not changed compared to Example B2.

### Example B5

A coated film was prepared as described in B1. In contrast to example B1, the first side of the film was not coated with the dispersion A(a). Instead, a second primer layer was formed on the primer layer P1 of the first side, as follows

60.5% By weight DSM NeoCryl® FL-711

10.0% by weight Vinavil MF2

1.0% by weight DSM Crosslinker® CX-100

4.0% by weight isopropanol

24.5% by weight water.

The coating weight of the second primer layer was about 0.5 g/m². Subsequently, this secondary primer layer was coated with a PVDC dispersion of the following composition:

86.5% by weight Solvin Diofan® A 114

4.0% by weight Michelman Michem® Lube 160PF

0.5% by weight Lanxess Mersolat® H₃₀

1.0% by weight of a 12% dispersion of Grace Davison Syloid® 244 in water

8.0% by weight water

The coating weight of the PVDC coating was 0.9 g/m². Otherwise, the coatings of the film were not changed compared to Example B2.

### Comparative Example VB1

A coated film was prepared as described in B1. In contrast to example B1, the inner polyacrylate layer on side 2 was omitted.

In this way, a film was produced which had the following layer structure: outer polyacrylate layer with antiblocking agent and wax/primer/boPP/primer/outer polyacrylate layer with antiblocking agent and wax. The outer coatings of the film were not changed compared to Example B1.

### Comparative Example VB2

A coated film was prepared as described in VB1. In contrast to example VB1, the coating weight of the polyacrylate layer B2(a) on side 2 of the film was increased. The coating weight of this outer polyacrylate layer B2(a) with antiblocking agent and wax was now 1.8 g/m².

### Comparative Example VB3

A coated film was produced as described in B2. Unlike Example B2, only one coating of dispersion A (i) was applied to both sides, i.e., the two outer polyacrylate layers B1(a) were omitted.

In this way a film was produced which had the following layer structure: outer polyacrylate layer without antiblocking agent and without wax/primer/boPP/primer/outer polyacrylate layer without antiblocking agent and without wax. This film was no longer processable due to poor friction and poor running behavior after winding.

The composition of the films according to the examples and the comparative examples are again summarized in Table 1 below:

TABLE 1

| | Example 1 | | Example 2 | | Example 3 | | Example 4 | | Example 5 | | VB1 | | VB2 | | VB3 | |
|---|---|---|---|---|---|---|---|---|---|---|---|---|---|---|---|---|
| B1(a) | 0.9 | g/m² | 0.8 | g/m² | 0.9 | g/m² | 1.0 | g/m² | 0.9 | g/m²* | 0.8 | g/m² | 0.9 | g/m² | | |
| B1(i) | | | 1.0 | g/m² | 0.9 | g/m² | 1.3 | g/m² | | | | | | | 0.9 | g/m² |
| P1 | 0.1 | g/m² | 0.1 | g/m² | 0.1 | g/m² | 0.1 | g/m² | 0.6 | g/m² | 0.1 | g/m² | 0.1 | g/m² | 0.1 | g/m² |
| BOPP | 20 | μm | 20 | μm | 20 | μm | 20 | μm | 20 | μm | 20 | μm | 20 | μm | 20 | μm |
| P2 | 0.1 | g/m² | 0.1 | g/m² | 0.1 | g/m² | 0.1 | g/m² | 0.1 | g/m² | 0.1 | g/m² | 0.1 | g/m² | 0.1 | g/m² |
| B2(i) | 1.0 | g/m² | 1.0 | g/m² | 1.3 | g/m² | 1.3 | g/m² | 1.0 | g/m² | | | | | 0.9 | g/m² |
| B2(a) | 1.0 | g/m² | 0.9 | g/m² | 1.0 | g/m² | 1.0 | g/m² | 1.0 | g/m² | 0.9 | g/m² | 1.8 | g/m² | | |

*additional second primer layer and PVDC coating

The results for the examples and the comparative examples are summarized in Table 2:

TABLE 2

| | | | | Measurement was made 76 days after storage | | | | |
|---|---|---|---|---|---|---|---|---|
| | | | | of the samples at 40° C.; This matches with | | | | |
| | | | | a duration of 365 days at room temperature | | | | |
| Example | Film side | Appl. weight Sum | | COF | C17 | DPP | MBP | |
| B1 | Side 1 | 0.9 | g/m² | ++ | + | ++ | ++ | |
| | Side 2 | 2.0 | g/m² | ++ | | | | Inner layer |
| | | | | | | | | without additive |
| B2 | Side 1 | 1.8 | g/m² | ++ | ++ | ++ | ++ | Inner layer |
| | | | | | | | | without additive |
| | Side 2 | 1.9 | g/m² | ++ | | | | Inner layer |
| | | | | | | | | without additive |
| B3 | Side 1 | 1.8 | g/m² | ++ | ++ | +++ | +++ | Inner layer |
| | | | | | | | | without additive |
| | Side 2 | 2.3 | g/m² | ++ | | | | Inner layer |
| | | | | | | | | without additive |
| B4 | Side 1 | 2.3 | g/m² | ++ | +++ | +++ | +++ | Inner layer |
| | | | | | | | | without additive |
| | Side 2 | 2.3 | g/m² | ++ | | | | Inner layer |
| | | | | | | | | without additive |
| B5 | Side 1 | 0.9 | g/m² | ++ | +++ | +++ | +++ | Sec. primer + |
| | | | | | | | | PVDC |
| | Side 2 | 2.0 | g/m² | ++ | | | | Inner layer |
| | | | | | | | | without additive |
| VB1 | Side 1 | 0.8 | g/m² | ++ | − | − | ◯ | |
| | Side 2 | 0.9 | g/m² | ++ | | | | |
| VB2 | Side 1 | 0.9 | g/m² | ++ | − | ◯ | ◯ | |
| | Side 2 | 1.8 | g/m² | ++ | | | | |
| VB3 | Side 1 | 0.85 | g/m² | −− | + | ++ | ++ | Outer layer |
| | | | | | | | | without additive |
| | Side 2 | 0.85 | g/m² | −− | | | | Outer layer |
| | | | | | | | | without additive |

Valuation key: % of the surrogate substance transferred

TABLE 3

| | |
|---|---|
| −− | >2.5% |
| − | 1.5% to <2.5% |
| O | 1.0% to <1.5% |
| + | 0.5% to <1.0% |
| ++ | 0.1% to <0.5% |
| +++ | <0.1% |

What is claimed is:

1. A food packaging comprising:
A) a coated film which is capable of contact with food,
B) a cardboard based on a recycled cardboard, which is in contact with the coated, biaxially oriented polypropylene film, characterized in that the coated film B) comprises:
(a) a biaxially oriented polypropylene film comprising on at least one surface;
(b) at least a first primer layer P1 in contact with a surface of the biaxially oriented polypropylene film; and
(c) a first inner coating B1(i) which is in contact with the first primer layer and which contains no particulate additives and which comprises:
(i) at least one polymer based on acrylate; or
(ii) halogen-containing vinyl and/or vinylidene polymers; or
(iii) at least one polymer on vinyl alcohol (VOH); and
(d) comprises a first outer coating B1(a) which is in contact with the first inner coating B1(i) and which forms the outer surface of the coated film and contains friction reducing additives and which comprises:
(i) at least one polymer based on acrylate; or
(ii) halogen-containing vinyl and/or vinylidene polymers; or
(iii) at least one polymer based on vinyl alcohol (VOH).

2. The food packaging according to claim 1, characterized in that the biaxially oriented polypropylene film comprises, on the second opposing surface:
(b) a second primer layer P2 in contact with the second surface of the biaxially oriented polypropylene film; and
(c) a second one inner coating B2(i) which is in contact with the second primer layer P2 and which contains no particulate additives and which comprises:
(i) at least one polymer based on acrylate; or
(ii) halogen-containing vinyl and/or vinylidene polymers; or
(iii) at least one polymer based on vinyl alcohol (VOH); and
(d) a second outer coating B2(a) which is in contact with the second inner coating B2(i) and which forms the second outer surface of the coated film and contains friction reducing additives and which contains:
(i) at least one polymer based on acrylate; or
(ii) halogen-containing vinyl and/or vinylidene polymers; or
(iii) at least one polymer based on vinyl alcohol (VOH).

3. The food packaging according to claim 1, characterized in that the coating weight of the primer layer(s) lies in each case in a range of 0.1 to 1.0 g/m².

4. The food packaging according to any one of claim 1, characterized in that the coating weight of the inner coating(s) B(i) lies in each case in a range of 0.5 to 1.5 g/m².

5. The food packaging according to any one of claim 1, characterized in that the coating weight of the outer coating(s) B(a) lies in each case in a range of 0.5 to 1.5 g/m².

6. The food packaging according to any one of claim 1, characterized in that the coating weight of the primer layer and of the inner coating and of the outer coating on one side of the film lies in total in a range of 1.5 to 4 g/m².

7. The food packaging according to any one of claim 1, characterized in that the outer coating(s) contain particulate additives having a particle size of 0.05 to 5 μm and in an amount of 0.01 to 15% by weight.

8. The food packaging according to any one of claim 1, characterized in that the outer coating(s) contain waxes in an amount of 2 to 10% by weight.

9. The food packaging according to any one of claim 1, characterized in that the primer layer(s) are composed of polyethyleneimine.

10. The food packaging according to any one of claim 1, characterized in that the outer coating(s) are composed of polymethyl methacrylate, polyethyl acrylate, polyethylmethyl acrylate, polybutyl acrylate or polymethyl acrylates or acrylate copolymers based on methyl methacrylate, ethyl acrylate, ethyl methacrylate and/or methyl acrylate.

11. The food packaging according to any one of claim 1, characterized in that the inner coating(s) are composed of polymethyl methacrylate, polyethyl acrylate, polyethylmethyl acrylate, polybutyl acrylate or polymethyl acrylates or acrylate copolymers based on methyl methacrylate, ethyl acrylate, ethyl methyl acrylate and/or methyl acrylate.

12. The food packaging according to any one of claim 1, characterized in that the inner and/or outer coating(s) composed of halogen-containing vinyl and/or vinylidene polymer are composed of a polymer based on vinyl chloride and/or vinylidene chloride.

13. The food packaging according to any one of claim 1, characterized in that the inner and/or outer coating(s) are composed of a mixture of ethylene vinyl alcohol (EVOH) and polyvinyl alcohol.

14. The food packaging according to any one of claim 1, characterized in that the recycled cardboard contains at least 300-1000 mg/kg of mineral oil, preferably MOSH and MOAH mineral oils, in particular of the types MOSH 14-24, MOSH 24-35, MOAH 14-24 and MOAH 24-35.

15. The food packaging according to any one of claim 1, further comprising the food in contact with the coated film.

16. A coated film comprising:
(a) a biaxially oriented polypropylene film having on at least one surface;
(b) at least a first primer layer P1, which is in contact with a surface of the biaxially oriented polypropylene film; and
(c) a first inner coating B1(i) which is in contact with the first primer layer P1 and which contains no particulate additives and which comprises:
(i) at least one polymer based on acrylate; or
(ii) halogen-containing vinyl and/or vinylidene polymers; or
(iii) at least one polymer based on vinyl alcohol (VOH); and
(d) a first outer coating B1(a) which is in contact with the first inner coating B1(i) and which forms the outer surface of the coated film and contains the friction reducing additives and:
(i) at least one polymer based on acrylate; or
(ii) halogen-containing vinyl and/or vinylidene polymers; or
(iii) at least one polymer based on vinyl alcohol (VOH).

17. The coated film according to claim 16, comprising on the second opposing surface of the biaxially oriented polypropylene film:
(b) a second primer layer P2 which is in contact with the second surface of the biaxially oriented polypropylene film; and
(c) a second inner coating B2(i) which is in contact with the second primer layer P2 and which contains no particulate additives and which comprises:
(i) at least one polymer based on acrylate; or
(ii) halogen-containing vinyl and/or vinylidene polymers; or
(iii) at least one polymer based on vinyl alcohol (VOH); and
(d) a second outer coating B2(a) which is in contact with the second inner coating B2(i) and which forms the second outer surface of the coated film and contains the friction reducing additives and which contains:
(i) at least one polymer based on acrylate; or
(ii) halogen-containing vinyl and/or vinylidene polymers; or
(iii) at least one polymer based on vinyl alcohol (VOH).

18. The coated film according to claim 16, comprising on the second opposing surface of the biaxially oriented polypropylene film:
(b) a second primer layer P2 in contact with the second surface of the biaxially oriented polypropylene film; and
(c) a second outer coating B2(a) which is in contact with the second primer layer P2 and which forms the second outer surface of the coated film and contains friction reducing additives and which contains:
(i) at least one polymer based on acrylate; or
(ii) halogen-containing vinyl and/or vinylidene polymers; or
(iii) at least one polymer based on vinyl alcohol (VOH).

19. Use of a coated film according to claim 16 for the manufacture of a packaging comprising a food and a cardboard based on a recycled cardboard, characterized in that the food is not in direct contact with the cardboard.

20. A laminated cardboard, characterized in that the cardboard is a cardboard based on a recycled cardboard and is laminated with a film according to claim 16.
